(19) United States
(12) Patent Application Publication
(10) Pub. No.: US 2014/0292832 A1
(43) Pub. Date: Oct. 2, 2014

(54) DISPLAY DEVICE, DISPLAY CONTROL DEVICE, AND DISPLAY CONTROL METHOD FOR THE SAME

(71) Applicant: PRINCETON TECHNOLOGY CORPORATION, New Taipei City (TW)

(72) Inventors: HWA HSIANG CHANG, New Taipei City (TW); CHENG HSI CHEN, New Taipei City (TW); FUMIKAZU OMOTO, New Taipei City (TW)

(73) Assignee: PRINCETON TECHNOLOGY CORPORATION, New Taipei City (TW)

(21) Appl. No.: 14/206,260

(22) Filed: Mar. 12, 2014

(30) Foreign Application Priority Data
Mar. 29, 2013 (TW) 102111345

(51) Int. Cl. G09G 5/10

(52) U.S. Cl. CPC G09G 5/10
USPC 345/690

(57) ABSTRACT

In a display control method applied to a display device including a display panel, statistics of luminance information of each row of display data is gathered and a statistical table of luminance information of each row of the display data is generated. A lookup table for each row of the display data, which defines a relationship between luminance and compensated pulse widths of each row of the display data, is generated according to the statistical table of luminance information of each row of the display data and a pulse width compensation table. Compensated display data is generated according to lookup tables of each row of the display data and the display data. Data driving signals and scan driving signals are generated according to the compensated display data. The data driving signals and the scan driving signals are outputted to the display panel to display an image.

### CROSS REFERENCE TO RELATED APPLICATIONS

This Application claims priority of Taiwan Patent Application No. 102111345, filed on Mar. 29, 2013, the entirety of which is incorporated by reference herein.

### BACKGROUND OF THE INVENTION

1. Field of the Invention

The invention is related to a display device, and more particularly to a display control technology for use with the display device.

2. Description of the Related Art

A current-driven display device comprises a plurality of current-driven display elements, such as organic light-emitting diodes. Display luminance of a current-driven display element is determined according to the magnitude and duration of the current flowing through the current-driven display element. Conventionally, pulse width modulation (PWM) is used to control the duration of the current flowing through the current-driven display element so as to make the current-driven display element to display different luminance (gray-level values).

FIG. 1 is a block diagram of a conventional display device 10, The display device 10 comprises an image circuit 100, a driving circuit 110 and a display panel 120. The image circuit 100 outputs display data signals 130 to the driving circuit 110. The driving circuit 110 outputs data driving signals 140 and scan driving signals 150 to the display panel 120 based on the display data signals 130. The display panel 120 then displays an image in response to the display data signals 130.

FIG. 2 is a block diagram of the display panel 120 in FIG. 1. The display panel 120 comprises a plurality of display elements (pixels) P configured in a matrix arrangement, a plurality of data lines D₁˜Dₘ for receiving the data driving signals 140 and a plurality of scan lines S₁˜Sₙ for receiving the scan driving signals 150. When the states of the data driving signals 140 in the same row of pixels are switched, the charging and discharging operations of parasitic capacitors on the display panel may he influenced, thereby generating crosstalk. The crosstalk may influence other display elements and cause inconsistency in display brightness, and thus image distortion may occur.

### BRIEF SUMMARY OF THE INVENTION

In view of this deficiency, the present disclosure provides a display control technology of a display device to compensate for display data so as to avoid inconsistency in display luminance caused by crosstalk,

An embodiment of the invention provides a display control method applied to a display device including a display panel, including the following steps of: receiving display data; gathering statistics of luminance information of each row of the display data and generating a statistical table of luminance information for each row of the display data; generating a lookup table storing the luminance and the compensated pulse widths of each row of the display data according to the statistical table of the luminance information of each row of the display data and a pulse width compensation table; generating compensated display data according to lookup tables storing the luminance and compensated pulse widths of each row of the display data and the display data; and generating data driving signals and scan driving signals according to the compensated display data and outputting the data driving signals and the scan driving signals to the display panel to display an image.

Another embodiment of the invention provides a display control system, comprising: an image circuit for generating display data signals; a compensation circuit for receiving display data in accordance with the display data signals, gathering statistics of luminance information of each row of the display data and generating a statistical table of luminance information of ach row of the display data, generating a lookup table storing luminance and compensated pulse widths of each row of the display data according to the statistical table of luminance information of each row of the display data and a pulse width compensation table, and generating compensated display data according to lookup tables storing luminance and compensated pulse widths of each row of the display data and the display data; and a drive circuit, coupled to the image circuit and the compensation circuit, for receiving the compensated display data from the compensation circuit, generating data driving signals and scan driving signals according to the compensated display data and outputting the data driving signals and the scan driving signals to a display panel to display an image.

Still another embodiment of the invention provides a display device, comprising: a display panel; and a display control system, comprising: an image circuit, generating display data signals; a compensation circuit, receiving display data in response to the display data signals, gathering statistics of luminance information of each row of the display data and generating a statistical table of luminance information of each row of the display data, generating a lookup table of luminance and compensated pulse widths of each row of the display data according to the statistical table of luminance information of each row of the display data and a pulse width compensation table, and generating compensated display data according to lookup tables of luminance and compensated pulse widths of each row of the display data and the display data; and a drive circuit, coupled to the image circuit and the compensation circuit, for receiving the compensated display data from the compensation circuit, generating data driving signals and scan driving signals according to the compensated display data and outputting the data driving signals and the scan driving signals to the display panel to display an image.

A detailed description is given in the following embodiments with reference to the accompanying drawings.

### BRIEF DESCRIPTION OF THE DRAWINGS

The invention can be more fully understood by reading the subsequent detailed. description and examples with references made to the accompanying drawings, wherein:

FIG. 1 is a block diagram of a conventional display device;

FIG. 2 is a schematic diagram of the display device in FIG. 1;

FIG. 3A is a block diagram partially showing a display panel;

FIG. 3B and FIG. 3C are charts showing the reciprocal relationship between the pulse width modulation signals and gray-level values;

FIG. 4 is a block diagram of a display device according to an embodiment of the invention;

FIG. 5 is a block diagram of a compensation circuit according to an embodiment of the invention;

FIG. 6 is a flow chart illustrating a display control method for a display device according an embodiment of the invention;

FIG. 7 is a chart depicting the constitution of a statistical table of luminance information of one row of display data;

FIG. 8A is a lookup table showing the relationship between the original luminance and pulse widths;

FIG. 8B is a statistical table showing the luminance information of one row of display data;

FIG. 8C shows a pulse width compensation table;

FIG. 8D is a lookup table showing the relationship between luminance and compensated pulse widths of one row of display data;

FIG. 9 is a flow chart illustrating a display control method for a display vice according to another embodiment of the invention; and

FIG. 10 is a flow chart illustrating a display control method for a display device according to another yet embodiment of the invention.

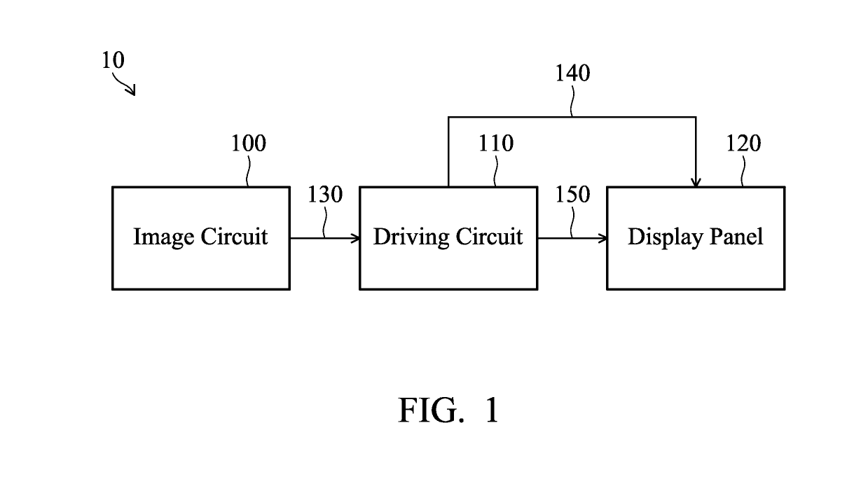

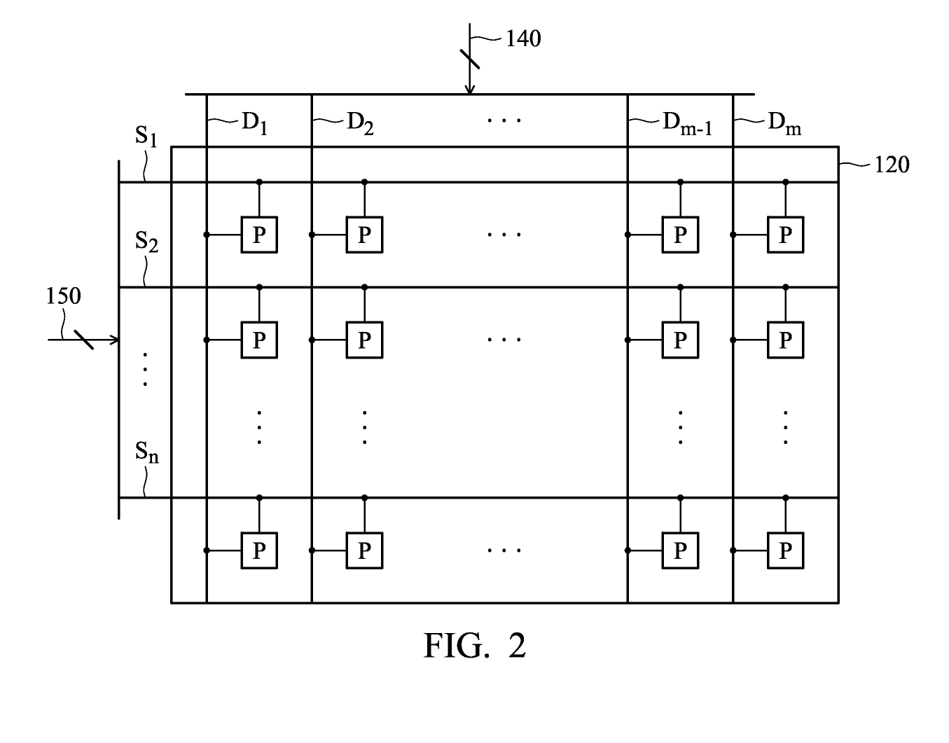

### DETAILED DESCRIPTION OF THE INVENTION

This description is made for the purpose of illustrating the general principles of the invention and should not be taken in a limiting sense. In addition, the present disclosure may repeat reference numerals and/or letters in the various examples. This repetition is for the purpose of simplicity and clarity and does not in itself dictate a relationship between the various embodiments and/or configurations discussed. The scope of the invention is best determined by reference to the appended claims.

It is understood that the following disclosure provides many different embodiments, or examples, for implementing different features of the application. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are formed in direct contact, and may also include embodiments in which additional features may he formed interposing the features, such that the features may not be in direct contact,

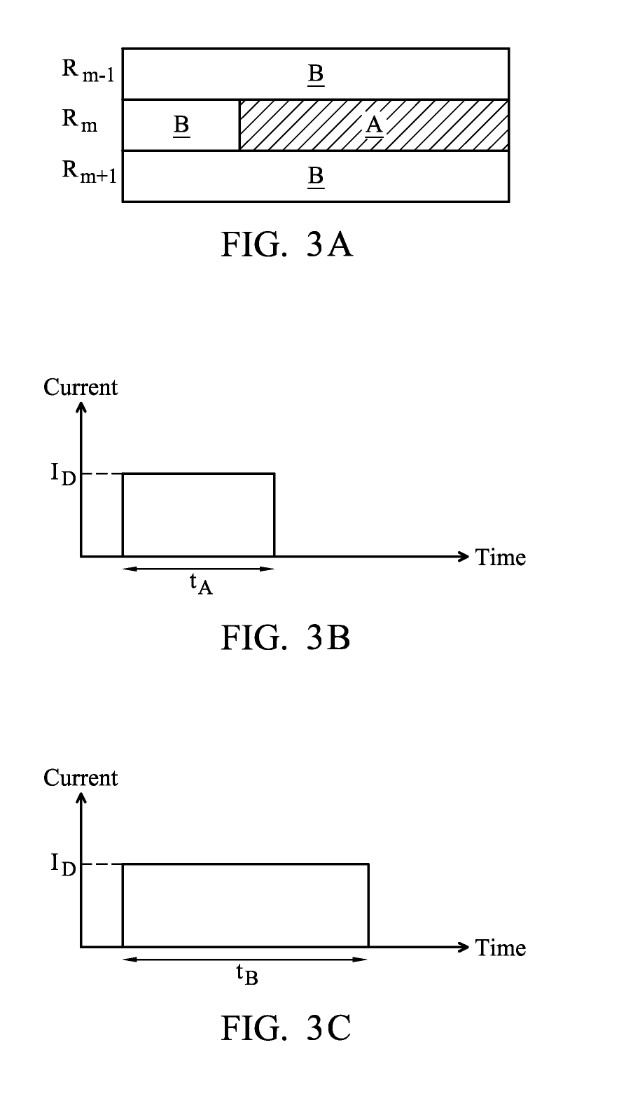

FIG. 3A partially illustrates a block diagram of display panel. As shown in FIG. 3A, in a pixel row Rm where pixels are activated by the same scan line, some pixels illuminate with a gray level B, and the other pixels illuminate with a gray level A. The brightness of the gray level A is lower than that of the gray level B. Moreover, in FIG. 3A, pixels in pixel rows Rₘ₋₁ and Rₘ₊₁ all illuminate with the gray level B. FIG. 3B illustrates an example of a chart depicting the e reciprocal relationship between a pulse width modulation signal and the gray level A. The magnitude of the current of the pulse width modulation signal corresponding to the gray level A is I_{D}, and the pulse width of the pulse width modulation signal corresponding to the gray level A is t_{A.} FIG. 3C illustrates an example of a chart depicting the reciprocal relationship between a pulse width modulation signal and the gray level B. The magnitude of the current of the pulse width modulation signal corresponding to the gray level B is I_{D}, and the pulse width of the pulse width modulation signal corresponding to the gray level B is t_{B}. When data driving signals received, by the pixels displaying the gray level A in the pixel row Rₘ are turned off, the parasitic capacitance of other pixels in the pixel row Rₘ will be charged, and thus the brightness of the gray level B in the pixel row R is greater than the brightness of the gray level B in the pixel rows Rₘ₋₁ and Rₘ₊. Therefore, there is inconsistency between the brightness of the gray level B in the pixel row Rₘ and the brightness of the gray level B in the pixel rows Rₘ₋and Rₘ₊₁, and the gray level B in the pixel row Rₘ has to be compensated.

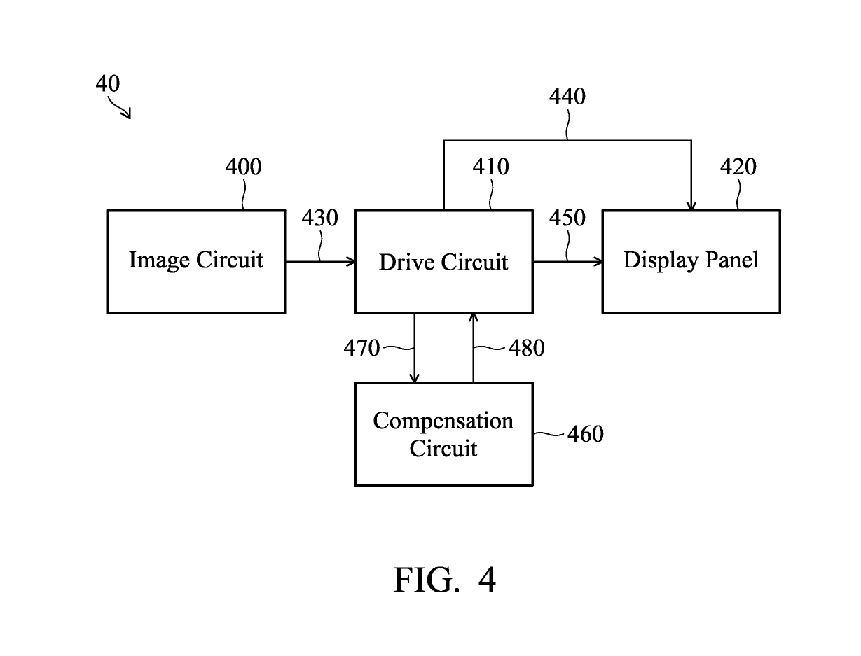

FIG. 4 illustrates a block diagram of a display device 40 according to an embodiment of the invention. The display device 40 comprises a display panel 420 and a display control system. The display control system comprises an image circuit 400, a drive circuit 410 and a compensation circuit 460. The image circuit 400 outputs display data signals 430 to the drive circuit 410. The drive circuit 410 transmits display data 470 in accordance with the display data signals 430 to the compensation circuit 460. The compensation circuit 460 gathers statistics of luminance information of each row of the display data 470 and generates a statistical table of luminance information of each row of the display data 470. The compensation circuit 460 further generates a lookup table storing luminance and compensated pulse widths of each row of the display data. 470 according to the statistical table of luminance information of each row of the display data 470 and a pulse width compensation table, and generates compensated display data 480 according to lookup tables storing luminance and compensated pulse widths of h row of the display data 470 and the display data 470. Then, the compensation circuit 460 transmits the compensated display data. 480 to the drive circuit 410. The drive circuit 410 goner t s data driving signals 440 and scan driving signals 450 according to the compensated display data 480 to the display panel 420. The display panel 420 displays a compensated image based on the compensated display data 480.

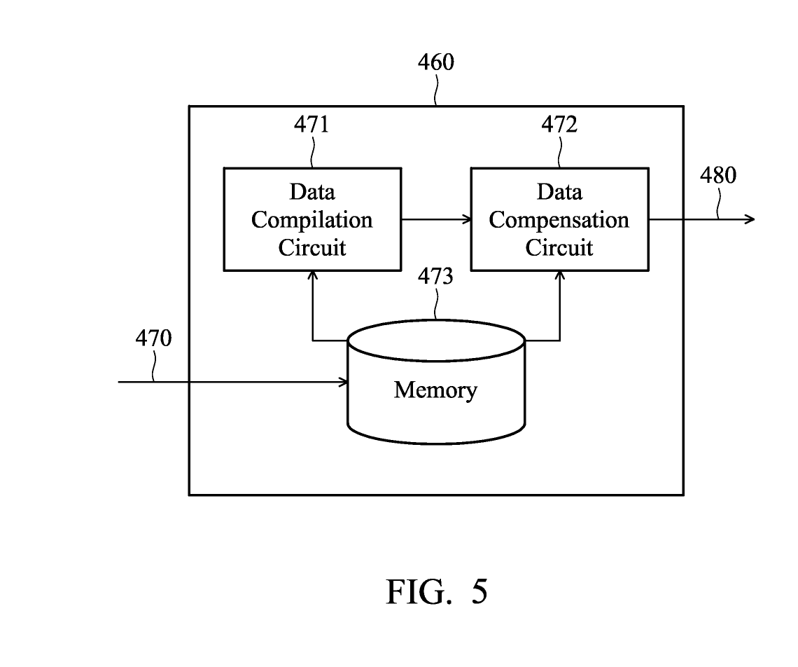

FIG. 5 illustrates a block diagram of the compensation circuit 460 according to an embodiment of the invention. The compensation circuit 460 comprises a data compilation circuit 471, a data compensation circuit 472 and a memory 473. The memory 473 receives and stores the display data 470. The data compilation circuit 471 accesses the display data 470 stored in the memory 473 and gathers statistics of luminance information of each row of the display data 470 to generate the statistical table of luminance information of each row of the display data 470. The data compilation circuit 471 transmits the statistical table of luminance information of each row of the display data 470 to the data compensation circuit 472. The data compensation circuit 472 generates the lookup table storing luminance and compensated pulse widths of each row of the display data 470 according to the statistical table of luminance information of each row of the display data 470 and a pulse width compensation table stored in the memory 473. The data compensation circuit 472 generates compensated display data 480 according to lookup tables of luminance and compensated pulse widths of each row of the display data 470 and the display data 470 and then transmits the compensated display data 480 to the drive circuit 410. The procedures for generating the statistical table of luminance information of each row of the display data, generating the lookup table of luminance and compensated pulse widths of each row of the display data and generating the compensated display data will be described in detail in the following.

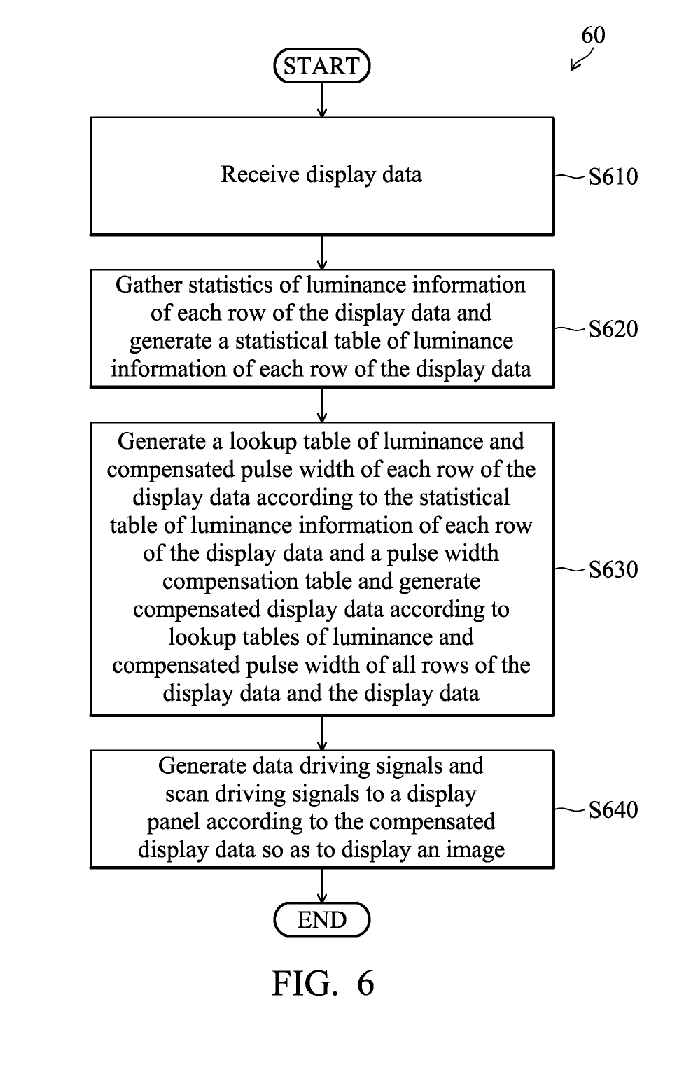

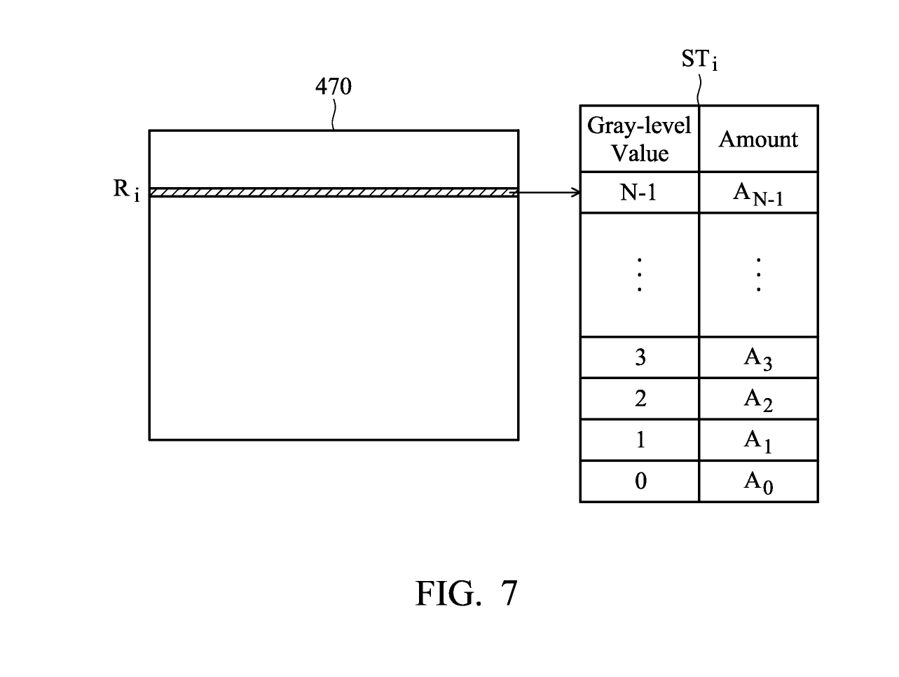

FIG. 6 illustrates a flowchart of a display control method 60 for a display device according to another embodiment of the invention. First, in step S610, display data, such as the display data 470, is received. In step S620, statistics of luminance information of each row of the display data are gathered, and a statistical table of luminance information of each row of the display data is generated. Take FIG. 7 as an example. FIG. 7 is a chart depicting a statistical table STᵢ of luminance information of a display data row Rᵢ of the display data 470. In this example, if a display panel is configured to comprise m×n display elements (pixels), the display data 470 is an m×n display data matrix. A value representative of each element of the display data 470 is a gray-level value (luminance value) to be displayed by a corresponding pixel in the display panel. The statistical table STᵢ of luminance information of the display data row Rᵢ records pixel amounts corresponding to gray level values in the display data row Rᵢ. For example, if there are A₃ pixels that are going to illuminate with a gray level value of 3 based on data of the display data row Rᵢ, the pixel amount corresponding to the gray-level value of 3 in the statistical table STᵢ of luminance information of the display data row Rᵢ will be A₃. The pixel amount corresponding to each gray-level value in the display data row Rᵢ can be deduced in a similar way. In this example and the following examples, the display panel displays N gray-level images with gray-level values being 0 to N-1. The gray-level value of 0 has the lowest luminance (for example, black) and the gray-level value of N-1 has the highest luminance (for example, white). N is a positive integer, such as 256. Statistical tables of luminance information of other display data rows in the display data 470 can be obtained in a similar way.

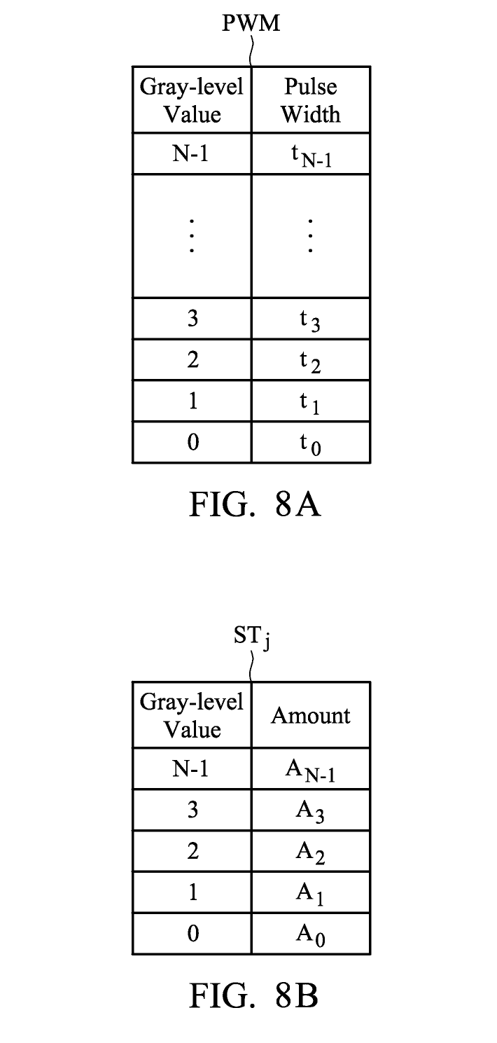

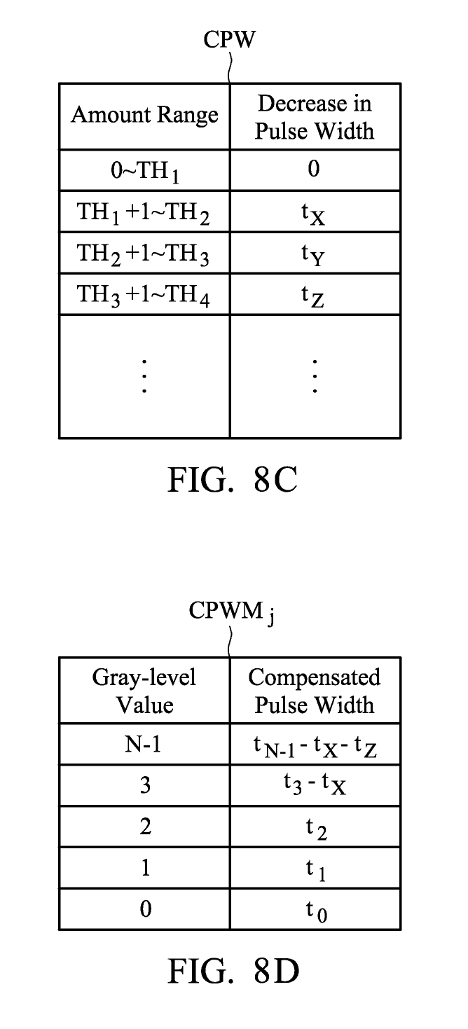

Then, in step S630, a lookup table of luminance and pulse widths of each row of the display data is generated according to the statistical table of luminance information of each row of the display data and a pulse width compensation table, and compensated display data, such as the compensated display data 480, is generated according to lookup tables of luminance and compensated pulse widths of each row of the display data and the display data. The method for generating the lookup table of luminance and compensated pulse widths of each row of the display data is described in the following with references made to FIG. 8A-8D. FIG. 8A. is a chart depicting a lookup table PWM of luminance and original pulse widths. In other words, the lookup table PWM of the original luminance. and pulse widths is a lookup table indicative of of the uncompensated luminance and pulse widths. The lookup table PWM of original luminance and pulse widths can be Written to and stored in the memory 473 before the display device was manufactured. FIG. 8B is a chart of a statistical table ST ⱼ of luminance information of a display data row R of the display data. The way to generate the statistical table STⱼ of luminance information of a display data row Rⱼ is similar to the way to generate statistical table STᵢ of luminance information of the display data row Rᵢ described above and will not be described again. For simplicity, information of some gray-level values corresponding to a pixel amount of 0 is omitted in the statistical table STᵢ. FIG. 8C is a block diagram of a pulse width compensation table CPW. The pulse width compensation table CPW can be set based on display characteristics of the display panel and can be written to and stored in the memory 473 before the display device was manufactured. FIG. 8D is a chart of a lookup table CPWMⱼ of luminance and compensated pulse widths of the display data row Rⱼ. The lookup table CPWMⱼ defines a relationship between luminance and compensated pulse widths for the display data row Rⱼ. Before compensation, an initial value of the compensated pulse width of each gray-level value in the lookup table CPWMⱼ is equal to a corresponding pulse width in the lookup table PWM of original luminance and pulse widths. During compensation, pulse widths of gray-level values (luminance values) that are not larger than a threshold TH_{G} are not compensated. In the example as shown in FIG. 8A˜8D, the threshold TH_{G} is equal to 1. Therefore, as shown in FIG. 8D, pulse widths of gray-level values of 0 and 1. are not compensated, and pulse widths of gray-level values of 2˜N-1 are compensated. In one example, the compensation is performed in an order from the lowest gray-level value to the highest gray-level value. For example, first, regarding the gray-level value of 2, it is known from the statistical table STⱼ that the pixel amount corresponding to the gray-level value of 1 is A₁. It is assumed that A₁ is within the amount rage of 0˜TH₁. Based on the pulse width compensation table CPW, it is known that a decrease in pulse width corresponding to the amount range of 0˜TH₁ is 0. Therefore, when it is desired to compensate the pulse width of the gray-level Value of 2, pulse widths of gray-level values of 2˜N-1. are not reduced. Afterwards, regarding the gray-level value of 3, it is known from the statistical table STⱼ that the pixel amount corresponding to the gray-level value of 2 is A₂. It is assumed that A₂ is within the amount range of Based on the pulse width compensation table CPW, it is known that a decrease in pulse width corresponding to the amount range of TH₁+1˜TH₂ is tₓ. Therefore, tₓ is subtracted from the pulse widths of the gray-level values of 3˜N-1, as shown in FIG. 8D. Next, regarding the gray-level value of 4, it is known from the statistical table STⱼ that the pixel amount corresponding to the gray-level value of 3 is A₃. It is assumed that A₃ is within the amount rage of TH₃+1˜TH₄. Based on the pulse width compensation table CPW, it is known that a decrease in pulse width corresponding to the amount range of TH₃+1˜TH₄ is t_{z}. Therefore, t_{z} is further subtracted from the pulse widths of gray-level values of 4˜N-1, as shown in FIG. 8D. Then, regarding gray-level values of 5˜N-1, since a decrease in pulse width corresponding to a previous gray-level value is 0, the pulse widths of gray-level values of 5˜N-1 are not reduced any more. It should be noted that since pixel amounts corresponding to gray-level values of 4˜N-2 are 0 in the statistical table Sⱼ, information of gray-level values of 4˜N-2 is omitted from the lookup table CPWM; for simplicity. After the compensation operation is completed, the compensated pulse width corresponding to the gray-level value of 3 is t₃-tₓ, and the compensated pulse width corresponding to the gray-level value of N-1 is t_{N-1}-tₓ-t_{z}. It should be noted that compensated pulse widths has to increase progressively as gray-level values increase in the lookup table of luminance and compensated pulse widths after compensation. For example, (t₃-tₓ)>t₂.

The method for generating lookup table CPWMⱼ described above can be applied to other display data rows to obtain a lookup table of luminance and compensated pulse widths of each row of the display data. In an example where a display panel is configured to comprise m×n display elements, n lookup tables CPWM₁˜CPWMₙ of luminance and compensated pulse widths are generated. Then compensated display data is generated according to the lookup tables CPWM₁˜CPWMₙ and original display data. For example, the compensated display data 480 may comprise the display data 470 and the lookup tables CPWM₁˜CPWMₙ. In step S640, data driving signals and scan driving signals are generated according to the compensated display data and are transmitted to the display panel. The display panel displays an image based on the data driving signals and the scan driving signals.

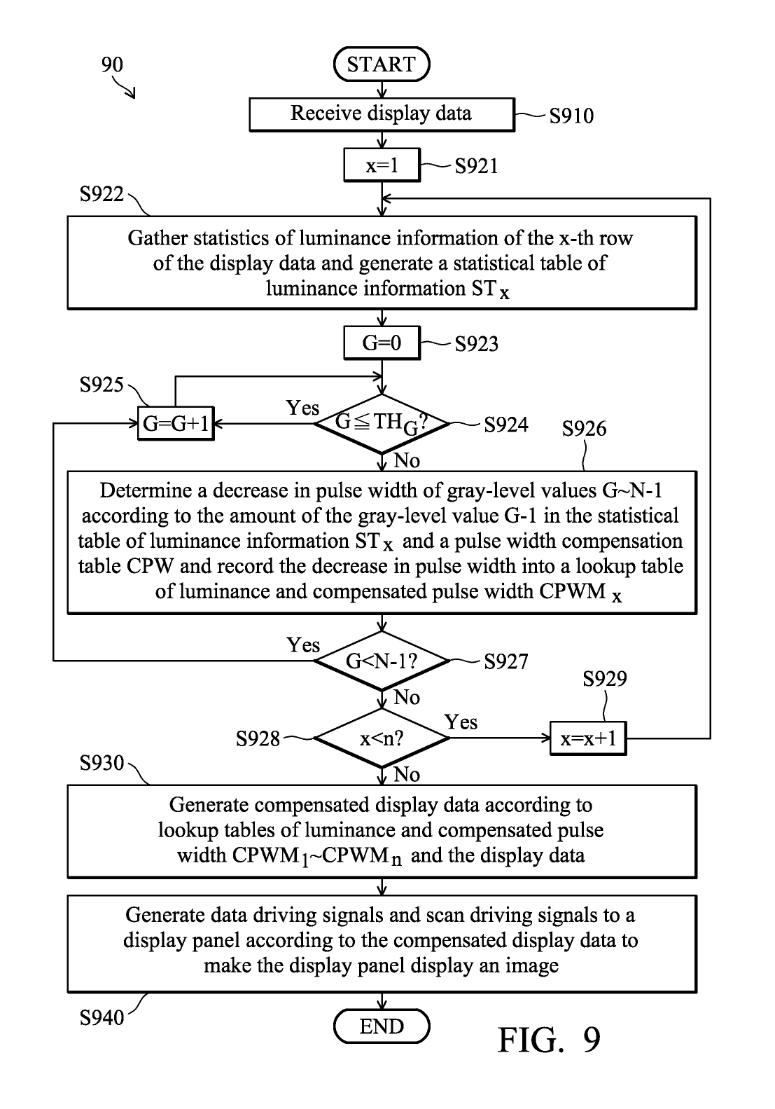

FIG. 9 illustrates a flowchart of a display control method 90 for a display device according to another embodiment of the invention. In step S910, display data is received. In step S921, an initial value of x that indicates a serial number of a row of the display data (display data row) to be processed is set to be 1. Steps S922˜S927 are performed to compensate for an x-th row of the display data and generate a lookup table CPWM of luminance and compensated pulse widths of the x-th row of the display data. In an example where a display panel is configured to comprise m×n display elements, and x=1˜n. In step S922, statistics of luminance information of the x-th row of the display data are gathered and a statistical table STₓ of luminance information of the x-th row of the display data, such as the statistical table STⱼ of luminance information of the j-th row of the display data as shown in FIG. 8B, is generated. In step S923, an initial value of a gray-level value G is set to be 0. In step S924, whether or not the gray-level value G is smaller than or equal to a gray-level value threshold TH_{G} is determined. If the gray-level value G is smaller than or equal to the gray-level value threshold TH_{G} (step S924: Yes), which means that compensation forth gray-level value G doesn't have to be performed, then, as shown in step S925, G=G+1, and the method proceeds back to step S924. If the gray-level value G is larger than the gray-level value threshold TH_{G} (step S924: No), which means that compensation has to be performed, then the method proceeds to step S926. In step S926, a decrease in pulse width of gray-level values GN˜1 is determined according to a pixel amount corresponding to a gray-level value G-1 in the statistical table STₓ and a pulse width compensation table CPW, and the decrease in pulse width is recorded into the lookup table CPWMₓ, that is, the decrease in pulse width corresponding to the pixel amount of the gray-level value G-1 is subtracted from each of pulse widths of gray-level values G˜N-1 in the lookup table CPWMₓ. Then in step S927, whether G is smaller than N-1 is determined. If G is smaller than N-1 (step S927: Yes), which means that not all gray-level values are compensating, then, as shown in step S925, G is set to be G+1, and the method proceeds back to step S924 to perform compensation for the next gray-level value. If G is not smaller than N-1 (step S927: No), which means the compensation for all gray-level values in the x-th row of the display data is finished, then, as shown in step S928, whether x is smaller than n is determined. If x is smaller than n, which means that not all display data rows of the display data are compensated, then, as shown in step S929, x is set to be x+1, and the method proceeds back to step S922 to perform compensation for the next row of the display data. If x is not smaller than n, which means that all rows of the display data are compensated and all lookup tables CPWM₁˜CPWMₙ of luminance and compensated pulse widths are obtained, then, as shown in step S930, compensated display data is generated according to the lookup tables CPWM₁CPWMₙ and the display data. In step S940, driving signals and scan driving signals are generated according to the compensated display data and then transmitted to the display panel to make the display panel display a compensated image.

As described in the embodiments above, in the display control system and the display control method of the invention, the inconsistency in luminance of pixels with high gray-level values caused by early shutdown of data driving signals corresponding to pixels with low gray-level values as a result of charging/discharging operation in each pixel row can be effectively compensated.

In the embodiments described above, the amount ranges of the pulse width compensation table CPW (i.e., pixel amount thresholds TH₁, TH₂ and TH₃) and corresponding decreases in pulse width in the pulse width compensation table CPW can be determined according to display characteristics of the display panel. In this example, the display panel may display a pattern like the pattern in FIG. 3A, and a brightness sensor can be used to measure decreases in pulse width corresponding to different pixel amount ranges.

In the embodiments as described, above, the single pulse width compensation table CPW is used to compensate for all gray-level values. In another embodiment, a multiplicity of pulse width compensation tables, each of which corresponds to a respective gray-level value or a respective gray-level value range, can be used for compensation.

In the embodiments described above, the gray-level value threshold TH_{G} can be determined according to characteristics of the display panel. For example, pulse widths not larger than a pulse width threshold are determined, not to be compensated based on the data current and the PWM control method of the display panel, and the pulse width threshold is used to determine the gray-level value threshold TH_{G}.

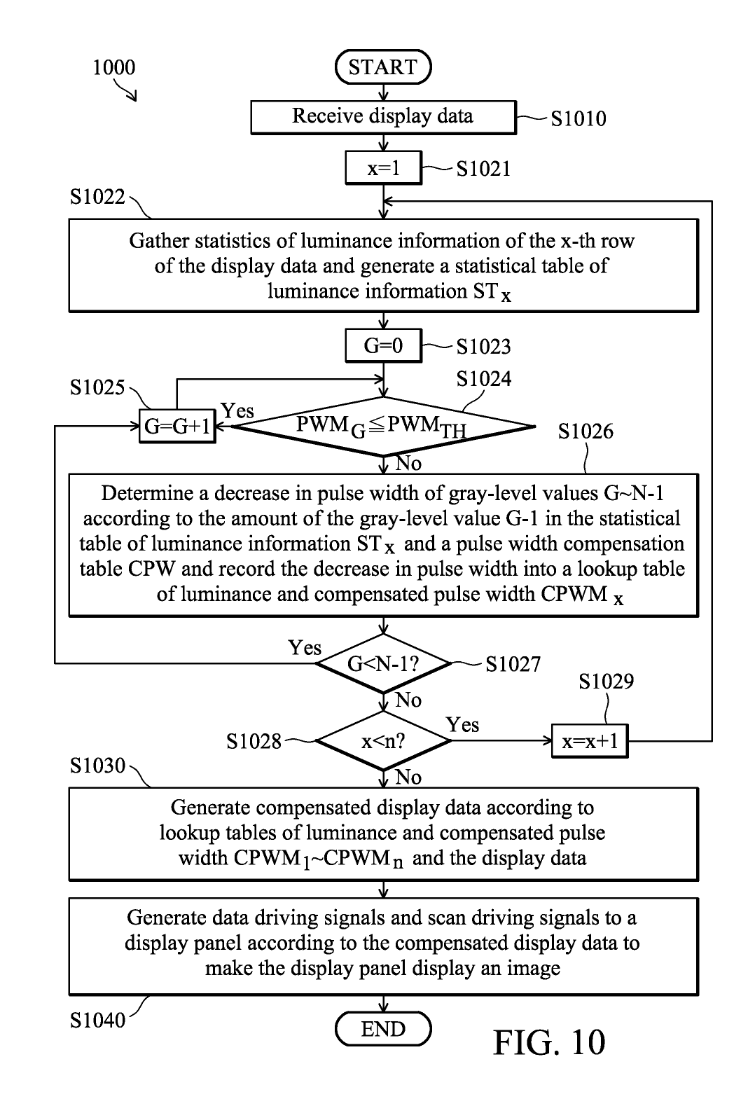

FIG. 10 illustrates a flowchart of a display control method 1000 for a display device according to another embodiment of the invention, The display control method 1000 and the display control method 90 are similar, and the main difference is indicated in step S1024. In step S1024, a pulse width threshold PWM_{TH} replaces the gray-level value threshold TH_{G}, and it is determined whether the pulse width PWM_{G} corresponding to the gray level G is smaller than or equal to the pulse width threshold PWM_{TH}. If the pulse width PWM_{G} corresponding to the gray level G is smaller than or equal to the pulse width threshold PWM_{TH}, which means that the pulse width PWM_{G} doesn't have to be compensated, then, as shown in step S1025, G is set to be G+1, and the method proceeds back to step S1024. If the pulse width PWM_{G} corresponding to the gray level G is larger than the pulse width threshold PWM_{TH}, it is determined that the pulse width PWM_{G} has to be compensated, then the method proceeds to step S1026 and goes on.

In the embodiment described above, the pulse width threshold PWM_{TH} can he determined according to characteristics of the display panel. For example, the pulse width threshold PWM_{TH} can be determined according to the data current and PWM control method of the display panel, and pulse widths that are smaller than the pulse width threshold PWM_{TH} are not compensated for.

Methods and systems of the present disclosure, or certain aspects or portions of embodiments thereof, may take the form of a program code (i.e., instructions) embodied in media, such as floppy diskettes, CD-ROMS, hard drives, firmware, or any other non-transitory machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by ways of examples and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display control method applied to a display device including a display panel, comprising:
receiving display data;
gathering statistics of luminance information of each row of the display data and generating a statistical table of luminance information for each row of the display data;
generating a lookup table of luminance and compensated pulse widths of each row of the display data according to the statistical table of luminance information of each row of the display data and a pulse width compensation table;
generating compensated display data according to lookup tables of luminance and compensated pulse widths of all rows of the display data and the display data; and
generating data driving signals and scan driving signals according to the compensated display data and outputting the data driving signals and the scan driving signals to the display panel to display an image.

2. The display control method as claimed in claim 1, wherein the display data is arranged in a matrix format corresponding to a display element matrix of the display panel.

3. The display control method as claimed in claim 2, wherein the display panel. displays an N gray-level image including gray-level values of 0 to N-1, and the step of gathering statistics of luminance information of each row of the display data and generating th statistical table of luminance information of each row of the display data further comprises:
calculating a pixel amount corresponding to each gray-level value of each row of the display data.

4. The display control method as claimed in claim 3, wherein the step of generating the lookup table of luminance and compensated pulse widths of each row of the display data according to the statistical table of luminance information of each row of the display data and the pulse width compensation table further comprises:
for each gray-level value G of each row of the display data exceeding a gray-level value threshold,
looking up the pulse width compensation table based on a pixel amount corresponding to a gray-level value G-1 to obtain a decrease in pulse width corresponding to the pixel amount, wherein the pixel amount corresponding to the gray-1 value G-1 is obtained from the statistical table of luminance information; and
subtracting the decrease in pulse width from each of pulse widths corresponding to gray-level values G to N-1 in the lookup table.

5. The display control method as claimed in claim 4, wherein the pulse width compensation table, a decrease in pulse width corresponding to a pixel amount that doesn't exceed a pixel amount threshold is 0.

6. The display control method as claimed in claim 3, wherein a pulse width that doesn't exceed a pulse width threshold is not compensated.

7. A display control system, comprising:
an image circuit, generating display data signals;
a compensation circuit, for receiving display data corresponding to the display data signals, gathering statistics of luminance information of each row of the display data and generating a statistical table of luminance information of each row of the display data, generating a lookup table of luminance and compensated pulse widths of each row of the display data according to the statistical table of luminance information of each row of the display data and a pulse width compensation table, and generating compensated display data according to lookup tables of luminance and compensated pulse widths of all rows of the -display data and the display data and
a drive circuit, coupled to the image circuit and the compensation circuit, for receiving the compensated display data from the compensation circuit, generating data driving signals and scan driving signals according to the compensated display data and outputting the data driving signals and the scan driving signals to a display panel to display an image.

8. The display control system as claimed in claim 7, wherein the display data is arranged in a matrix format corresponding to a display element matrix of the display panel.

9. The display control system as claimed in claim 8, wherein the display panel displays an N gray-level image including gray-level values of 0 to N-1, the compensation circuit further calculates a pixel amount corresponding to each gray-level value of each row of the display data to generate the statistical table of luminance information of each row of the display data.

10. The display control system as claimed in claim 9, wherein for each gray-level value G of each row of the display data that exceeds a gray-level value threshold, the compensation circuit looks up the pulse width compensation table based on a pixel amount corresponding to a gray-level value G-1 to obtain a decrease in pulse width corresponding to the pixel amount, wherein the pixel amount corresponding to the gray-level value G-1 is obtained from the statistical table of luminance information, and the compensation circuit substrates the decrease in pulse width from each of pulse widths corresponding to gray-level values G to N-1 in the lookup table.

11. The display control system as claimed in claim 10, wherein in the pulse width compensation table, a decrease in pulse width corresponding to a pixel amount that doesn't exceed a pixel amount threshold is 0.

12. The display control system as claimed in claim 9, wherein the compensation circuit doesn't compensate for a pulse width that doesn't exceed a pulse width threshold.

13. A display device, comprising:
a display panel; and
a display control system, comprising:
an image circuit, generating display data signals;
a compensation circuit, receiving display data corresponding to the display data signals, gathering statistics of luminance information of each row of the display data and generating a statistical table of luminance information of each row of the display data, generating a lookup table of luminance and compensated pulse widths of each row of the display data according to the statistical table of luminance information of each row of the display data and a pulse width compensation table, and generating compensated display data according to lookup tables of luminance and compensated pulse widths of each row of the display data and the display data; and
a drive circuit, coupled to the image circuit and the compensation circuit, for receiving the compensated display data from the compensation circuit, generating data driving signals and scan driving signals according to the compensated display data and outputting the data driving signals and the scan driving signals to the display panel to display an image.

14. The display device as claimed in claim 13, wherein the display data is arranged in a matrix format corresponding to a display element matrix of the display panel.

15. The display device as claimed in claim 14, wherein the display panel displays an N gray-level image including gray-level values of 0 to N-1, the compensation circuit further calculates a pixel amount corresponding to each gray-level value of each row of the display data to generate the statistical table of luminance information of each row of the display data.

16. The display device as claimed in claim 15, wherein for each gray-level value G of each row of the display data that exceeds a gray-level value threshold, the compensation circuit looks up the pulse width compensation table based on a pixel amount corresponding to a gray-level value G-1 to obtain a decrease in pulse width corresponding to the pixel amount, wherein the pixel amount corresponding to the gray-level value G-1 is obtained from the statistical table of luminance information, and the compensation circuit substrates the decrease in pulse width from each of pulse widths corresponding to gray-level values G to N-1 in the lookup table.

17. The display device as claimed in claim 16, wherein in the pulse width compensation table, a decrease in pulse width corresponding to a pixel amount that doesn't exceed a pixel amount threshold is 0.

18. The display device as claimed in claim 15, wherein the compensation circuit doesn't compensate for a pulse width that doesn't exceed a pulse width threshold.
